(19) United States
(12) Patent Application Publication
(10) Pub. No.: US 2023/0040301 A1
(43) Pub. Date: Feb. 9, 2023

(54) METHOD FOR COMPARING AT LEAST TWO FLIGHT PLANS FROM A FIRST FLIGHT PLAN AND A SECOND FLIGHT PLAN, COMPUTER PROGRAM PRODUCT AND COMPARISON MODULE THEREOF

(71) Applicant: THALES, Courbevoie (FR)

(72) Inventors: Marc DA CONCEICAO, Toulouse (FR); Marc RIEDINGER, Toulouse (FR); Willy TOCQUEC, Toulouse (FR)

(21) Appl. No.: 17/789,066

(22) PCT Filed: Dec. 24, 2020
(86) PCT No.: PCT/EP2020/087854

§ 371 Date: Jun. 24, 2022

(30) Foreign Application Priority Data
Dec. 27, 2019 (FR) 1915665

(51) Int. Cl. G08G 5/00; G06Q 50/30

(52) U.S. Cl. CPC G08G 5/0039; G08G 5/0017; G08G 5/0095; G06Q 50/30

(57) ABSTRACT

The method comprises a step of simultaneous scanning the list of elements of each flight plan comprising for each given pair of a first scan index and a second scan index, a comparison between the first flight plan element whose position index corresponds to the first scan index and the second flight plan element whose position index corresponds to the second scan index, according to the following sub-steps
when the first element is identical to the second element, adding at least one of said elements in a resulting list with a “no difference” marker;
otherwise, adding in the resulting list, the first element with a marker “removed” and the second element with a marker “added”.

### CROSS-REFERENCE TO RELATED APPLICATIONS

The present application for patent is a National Stage Entry of International Application No. PCT/EP2020/087854, filed Dec. 24, 2020, which claims priority to French Patent Application No. 19 15665, filed Dec. 27, 2019. The disclosure of the priority documents are incorporated in their entirety by reference therein.

### FIELD OF THE INVENTION

The present invention relates to a method for comparing at least two flight plans among a first flight plan and a second flight plan.

The present invention further relates to a computer program product and an associated comparison module.

The field of the invention is that of the management of the flight of an aircraft.

### BACKGROUND OF THE INVENTION

Aircraft, as known per se, comprise navigation management systems such as e.g. the Flight Management System (FMS), used for defining a flight plan and for calculating a trajectory and predictions associated with said trajectory.

The flight plan is generally defined by a pilot before the flight.

However, in some cases, said flight plan may be subject to modifications during e.g. the flight of the aircraft.

In such cases, specialized applications of the FMS system allow a third-party system to submit a new flight plan to be followed by the aircraft.

Such a third-party system may be another on-board avionics system or a tablet which can be used by the pilot in the cockpit, as well as a system external to the aircraft such as a ground service or another aircraft.

Under the current state of the aeronautical procedure, the pilot has the obligation to perform a full analysis of a flight plan proposed to him from a third system during the flight and to decide whether or not to accept the flight plan.

The methods known from the prior-art propose an “all or nothing” approach insofar as a proposed flight plan is either fully accepted or fully rejected by the pilot.

Currently, the pilot is responsible for a manual check of the conformity and consistency of the proposed flight plan.

Most of the time, such control is tedious. Indeed, there is generally no technique allowing the pilot to make sure that a received flight plan is acceptable, nor to understand the nature of the modifications compared to the flight plan originally planned thereof.

### SUMMARY OF THE INVENTION

The purpose of the present invention is to simplify the tasks of the pilot when receiving a new flight plan, in particular, from a third-party system.

To this end, the subject matter of the present invention is a method for comparing at least two flight plans among a first flight plan and a second flight plan, each flight plan being associated with an ordered list of elements, each element being associated with a position index defining the position of the element on the list;

The method comprising:
a simultaneous step of scanning the list of elements of the first flight plan according to a first scan index and of the list of elements of the second flight plan according to a second scan index;

the scan step comprising for each given pair, a first scan index and a second scan index, a comparison between the element, called first element, of the first flight plan whose position index corresponds to the first scan index and the element, called second element, of the second flight plan whose position index corresponds to the second scan index, according to the following sub-steps:
when the first element is identical to the second element, adding at least one of said elements in a resulting list with a “no difference” marker;
when the first element is not identical to the second element and none of said elements is yet present in the resulting list, adding in the resulting list the first element with a “deleted” marker and the second element with an “added” marker;
incrementing each of the scan indices;
forming a data structure comprising the elements from all the flight plans in the order determined by the resulting list and for each of said elements, the corresponding marker.

According to other advantageous aspects of the invention, the comparison method comprises one or more of the following characteristics, taken individually or according to all technically possible combinations: —comparing the first element with the second element further comprises the following sub-step:
when the first element is not identical to the second element and the first element corresponds to an element, called the preceding element, of the second flight plan which was already processed during a previous comparison;
   deleting from the resulting list all elements after the preceding element, having the marker “added”;
   changing the marker of the preceding element to the “no difference” marker;
   in the resulting list, moving the preceding element to the end of said resulting list;
   setting the second scan index equal to the position index of the preceding element;
the comparison of the first element with the second element further comprises the following sub-step:
when the first element is not identical to the second element and the first element corresponds to an element, called the preceding element, of the second flight plan which was already processed during a previous comparison;
   deleting all elements from the resulting list after the preceding element, having the marker “added”;
   changing the marker of the preceding element to the “no difference” marker;
   in the resulting list, moving the preceding element to the end of said resulting list;
   setting the first scan index equal to the position index of the preceding element;
each flight plan further comprises descriptive data for each element, the method further comprising the following step:
   scanning the resulting list and for each scanned element with the “no difference” marking, comparing the descriptive data associated with each flight plan with the element corresponding to the scanned element and when said data are different, modifying the marker of the scanned element to a “modified” marker;
when, during the comparison, the first scan index or the second scan index exceeds the maximum number of elements in the first flight plan or the second flight plan, respectively, the first element or the second element is considered as an empty element not present in the resulting list and not identical to the second element and to the first element, respectively.
the method further comprises an analysis step of the resulting data structure comprising the formation of at least one block of unmodified common elements and of at least one block of distinctive elements;
the block or each block of distinctive elements being composed of one or more consecutive elements in the resulting list which have the marker “added” or “deleted”; and
the block or each block of unmodified common elements consisting of one or more consecutive elements of the resulting list having the marker “no difference”;
the analysis step further comprises the formation of at least one block of common modified elements;
the block or each block of modified common elements consisting of one or more consecutive elements of the resulting list having the marker “modified”;
the data structure shows in a text form comprising with regard to each element of the resulting list, the marker associated with said element;
each element associated with a flight plan is an internal element included in that flight plan;
each element associated with a flight plan is an external element associated with an internal element included in said flight plan.

The further subject matter of the invention relates to a computer program product including software instructions which, when implemented by computer hardware, implements the method as previously defined.

The further subject matter of the invention is a module for comparing at least two flight plans among a first flight plan and a second flight plan, comprising technical resources configured for implementing the method as defined above.

### BRIEF DESCRIPTION OF THE DRAWINGS

The characteristics and advantages of the invention will appear upon reading the following description, given only as a limiting example, and making reference to the enclosed drawings, wherein:

FIG. 1 is a schematic comparison module according to the invention;

FIG. 2 is a flowchart of a comparison method according to the invention, the method being implemented by the comparison module in FIG. 1;

FIGS. 3 to 11 are different views illustrating the implementation of the method shown in FIG. 2, according to an example of input data.

### DETAILED DESCRIPTION OF THE INVENTION

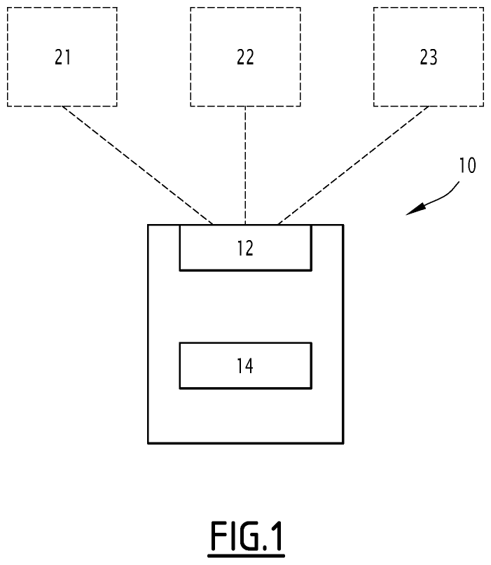

Indeed, FIG. 1 shows a comparison module 10 for at least two flight plans of an aircraft.

“Aircraft” refers to any flying machine which can be remotely piloted from a cockpit thereof, such as of an airplane, or which can also be remotely piloted by a pilot who is then at a distance from the flying machine, such as a drone.

A “flight plan” refers to an ordered list of elements and descriptive data corresponding to said elements, allowing at least part of the aircraft trajectory to be defined.

Such elements and descriptive data will subsequently be referred to as interior elements and interior descriptive data respectively, in order to underline the belonging thereof to the corresponding flight plan.

The flight plan is formed e.g. according to the ARINC 424 standard.

Thus, in accordance with this standard, each interior element of the flight plan comprises a physical point of passage of the aircraft called “waypoint” or a trajectory element called “leg”.

Moreover, as is known per se, each interior element is associated with interior descriptive data which have constraints such as a speed constraint, an altitude constraint, a desired time of passage, etc.

Such interior descriptive data therefore correspond to each element of the flight plan and represent data which vary depending on the nature of that element.

Advantageously according to the invention, at least some of the interior elements of a flight plan are further associated with one or more external elements, i.e. elements which are not comprised in the flight plan.

Such external elements are e.g. defined or determined or calculated from the interior elements of the flight plan.

Thus e.g. each external element associated with an interior element of a flight plan is chosen from the group comprising:
a procedure which can be used when flying over the corresponding interior element;
a geometrical element (curvature, extent, shape, etc.) of the geometry of the trajectory when flying over the corresponding interior element;
external descriptive data (such as e.g. constraints) other than interior descriptive data associated with the corresponding interior element.

Thereafter, unless explicitly stated, the term “element” shall be used interchangeably to designate an interior element of a flight plan or an external element associated with an interior element of such a plan.

Similarly, unless otherwise specified, the term “descriptive data” will be used interchangeably to refer to interior descriptive data of a flight plan or to external descriptive data of such a plan.

The comparison module 10 according to the invention is shown in more detail in FIG. 1.

Thus, as can be seen in FIG. 1, the comparison module 10 comprises a data receiver/transmitter 12 and a processing unit 14.

The data receiver/transmitter 12 is used for receiving data from external systems to be processed by the processing unit 14 and for transmitting processed data to said external systems or to other external systems.

In the example shown in FIG. 1, such external systems comprise e.g. a tablet 21, a flight management system of the FMS type 22, and a display interface 23.

The tablet 21 is e.g. a so-called open-world tablet of the aircraft, insofar as the data transmitted from said tablet are not protected according to the same aeronautical standards as the comparison module 10.

For example, the link between the receiver/transmitter 12 and this tablet 21 is a protected link to the avionics world, providing protection to filter data from the tablet 21 into the avionics world.

In particular, the tablet 21 is configured for sending to the data receiver/transmitter 12, a flight plan proposed to the pilot, e.g. during the flight of the aircraft.

The FMS type 22 system and the interface 23 are part of the avionics world insofar as the data exchanged with said systems have avionics data which are protected according to the same aeronautical standards as the comparison module 10 or according to standards providing a higher security level.

In particular, the FMS system 22 is apt to supply a flight plan to the data receiver/transmitter 12, e.g. the current flight plan of the aircraft.

The FMS system 22 is further apt to supply the receiver/transmitter 12 with initialization and performance data associated with the flight plan which was sent.

The FMS system 22 is further apt to supply the receiver/transmitter 12 with external elements and external descriptive data associated with the flight plan which was sent.

The display interface 23 has a communication interface between the pilot and the comparison module 10.

The interface 23 has e.g. a touch screen which allows the pilot to enter data for the data receiver/transmitter 12 and to display data coming from the data receiver/transmitter 12

The processing unit 14 is used to process input data from the receiver/transmitter 12 in order to produce output data.

In particular, the input data from the data receiver/transmitter 12 comprise at least two flight plans, one of said flight plans will be subsequently called first flight plan P1 and the other will be called second flight plan P2.

The first flight plan P1 comes e.g. from the FMS system 22 and corresponds to the current flight plan of the aircraft.

The second P2 flight plan comes from the tablet 21 and represents a flight plan proposed by a third party such as the airline company or any other ground service.

In a variant, the second flight plan P2 comes from a “Datalink” type on-board system which is thus also connected to the data receiver/transmitter 12.

The processing unit 14 is used to compare the two flight plans P1, P2 in order to generate a data structure summarizing all the differences and similarities between said flight plans.

To this end, the processing unit 14 is at least partly in the form of a software program or a programmable logic circuit such as an FPGA (Field-Programmable Gate Array).

In order to implement the operation of the processing unit 14, the comparison module 10 is integrated into an existing on-board computer of the aircraft or into a remote computer for the aircraft, e.g. a ground computer.

According to a particular embodiment of the invention, the comparison module 10 has a software and/or hardware component of the system of the FPGA type.

The comparison module 10 is in particular apt to implement a method for comparing at least two flight plans according to the invention.

Moreover, it is clear that such method can be applied in a similar manner for checking a flight plan among any number of flight plans.

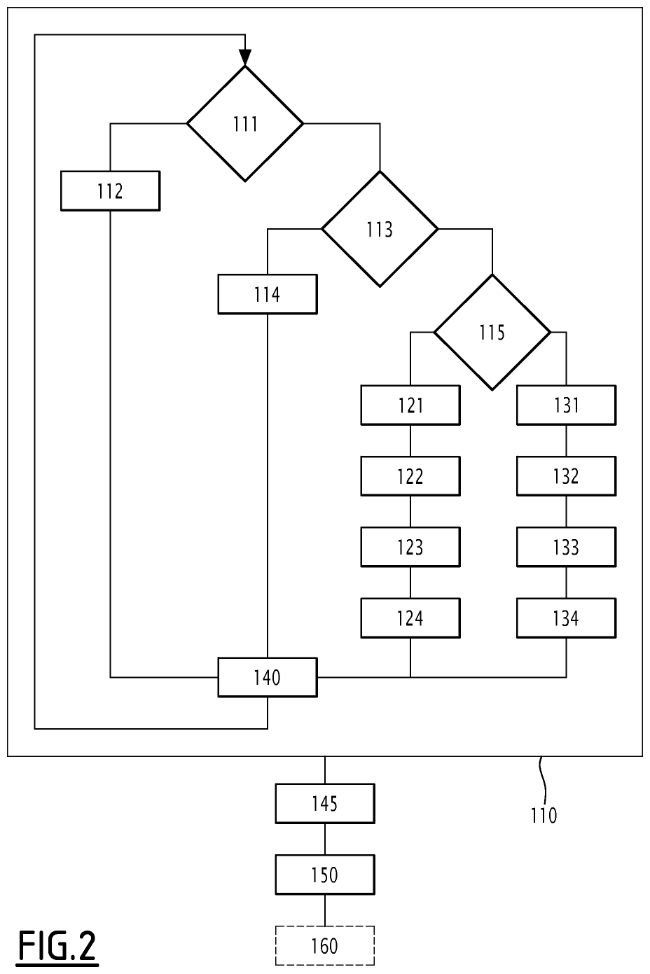

The method will now be explained making reference to FIG. 2 which shows a flowchart of the steps thereof.

It is initially considered that the data receiver/transmitter 12 receives two separate flight plans.

Among said flight plans, as explained above, a first flight plan P1 comes from e.g. the FMS system 22 and corresponds to the current flight plan of the aircraft, and a second P2 flight plan comes e.g. from the tablet 21 and corresponds to the flight plan submitted to the pilot for acceptance by the airline.

The method according to the invention comprises an initial step 110 of simultaneous scanning of the lists of elements associated with each of the flight plans P1, P2 provided.

Such element lists comprise e.g. all elements associated with the flight plans P1, P2.

According to another embodiment, said element lists comprise only some of the elements associated with the plans P1, P2.

In the latter case, the elements are e.g. chosen according to a criterion determined by a pilot. This criterion is related e.g. to a particular flight phase, to a particular time interval or to particular constraints.

To implement the scan, the processing unit 14 associates a first scan index with the list of elements associated with the first flight plan P1, said first index varying e.g. between 1 and the total number of elements associated with the first flight plan P1.

The processing unit 14 further associates a second scan index with the second flight plan P2, said scan index varying e.g. between 1 and the total number of elements associated with the second flight plan.

Initially, it is considered that each of these indices is equal to 1.

Then, the processing unit 14 implements a comparison between the elements of the different lists for each given pair of a first scan index and a second scan index.

In the following, the element associated with the first flight plan P1 associated with the first scan index will be called “first element” and the element associated with the second flight plan corresponding to the second scan index will be called “second element”.

The comparison therefore consists in comparing the first element with the second element at each iteration of the step 110 during the sub-steps described below.

Thus, in a first sub-step 111, the processing unit 14 determines whether or not the first element is the same as the second element.

If during the step 111 the first element is identical to the second element, the processing unit 14 implements the sub-step 112 during which the unit adds at least one of said elements to a resulting list with a “no difference” marker.

Otherwise, i.e. when the first element is not identical to the second element, the processing unit 14 determines during the step 113, whether at least one of said elements is already present in the resulting list.

If this is not the case, i.e. if none of said elements are still present in the resulting list, the processing unit 14, during the step 114, adds the first element with a “deleted” marker and the second element with a “added” marker to the resulting list.

It is therefore clear that during said step, the processing unit 14 associates the marker “deleted” with each specific element of the first flight plan P1 and the marker “added” to each specific element of the second flight plan P2.

Otherwise, i.e. when at least one of the elements is present in the resulting list, the processing unit 14 determines during the step 115, the nature of that element which is already present in the list.

Afterwards, said element which is already present in the list will be called the preceding element.

In particular, when it is the first element which corresponds to the preceding element, which thus comes from the second flight plan and which has already been processed during a previous comparison, the processing unit 14 implements the sub-steps 121 to 124.

When it is the second element which corresponds to the preceding element, which thus comes from the first flight plan and which has already been processed during a previous comparison, the processing unit 14 implements the steps 131 to 134.

It should be noted that the preceding element can be associated with both the first and the second flight plans. In such a case, the processing unit implements all of the sub-steps 121 to 124 and 131 to 134, e.g. in parallel.

During the sub-step 121, the processing unit 14 deletes all elements of resulting list coming after the preceding element having the marker “added”.

During the sub-step 122, the processing unit 14 changes the marker of the preceding element in the resulting list to the marker “no difference”.

During the sub-step 123, the processing unit 14 moves the preceding element in the resulting list to the end of said resulting list.

Finally, during the step 124, the processing unit sets the second scan index equal to the position index of the preceding element.

During the sub-step 131, the processing unit 14 deletes all elements of resulting list coming after the preceding element having the marker “deleted”.

During the sub-step 132, the processing unit 14 changes the marker of the preceding element in the resulting list to the marker “no difference”.

During the sub-step 133, the processing unit 14 moves the resulting element in the resulting list to the end of said resulting list.

Finally, during the sub-step 134, the processing unit 14 sets the second scan index equal to the position index of the preceding element.

At the end of all of the sub-steps described above, i.e. at the end of the sub-step 112 or of the sub-step 114 or of the sub-step 124 or of the sub-step 134, the processing unit 14 implements the step 140 during which said unit increments each of the scan indices.

Thus, via the next iteration of the step 110, a comparison can be implemented again for a new couple of the first scan index and the second scan index.

It should also be noted that when one of the scan indices exceeds the total number of elements in the corresponding list and the other scan index stays smaller than the total number of elements in the corresponding list, all previous sub-steps are e.g. implemented without considering the element associated with the flight plan for which the scan index has exceeded the total number of elements.

This is possible e.g. by associating the index which has exceeded the total number of elements, with an empty element which is then distant from any other element and which is not present in the resulting list.

And of course, the above sub-steps can be implemented according to other embodiments.

During the step 145, the processing unit 14 scans the resulting list and for each scanned element marked by “no difference” compares, the descriptive data associated with each flight plan with the element corresponding to the scanned element.

When said data are different, the processing unit 14 modifies the marker of the scanned element to the marker “modified”.

During the step 150 which was implemented after the initial step 110, the processing unit 14 forms a data structure comprising the elements associated with all the compared flight plans, in the order determined by the resulting list and for each of said elements.

In particular, advantageously according to the invention, said structure shows in a text form comprising e.g. with regard to each element of the resulting list, the marker associated with said element.

Moreover, according to an embodiment, the method according to the invention, further comprises a step 160 during which the processing unit 14 forms a plurality of blocks in the resulting data structure.

Each of said blocks groups together distinctive elements associated with the compared flight plans or common elements associated with said flight plans.

Thus, e.g. during the step 160, the processing unit 14 forms a plurality of unmodified common element blocks, a plurality of modified common element blocks, and a plurality of distinctive element blocks.

Each of the distinctive element blocks consists of one or a plurality of consecutive elements of the resulting list which have the marker “added” or “deleted”.

Each of the unmodified common element blocks consists of one or a plurality of consecutive elements of the resulting list which have the marker “no difference”.

Each of the modified common element blocks consists of one or a plurality consecutive elements of the resulting list which have the marker “modified”.

The separation in blocks is e.g. transcribed afterwards in the resulting data structure.

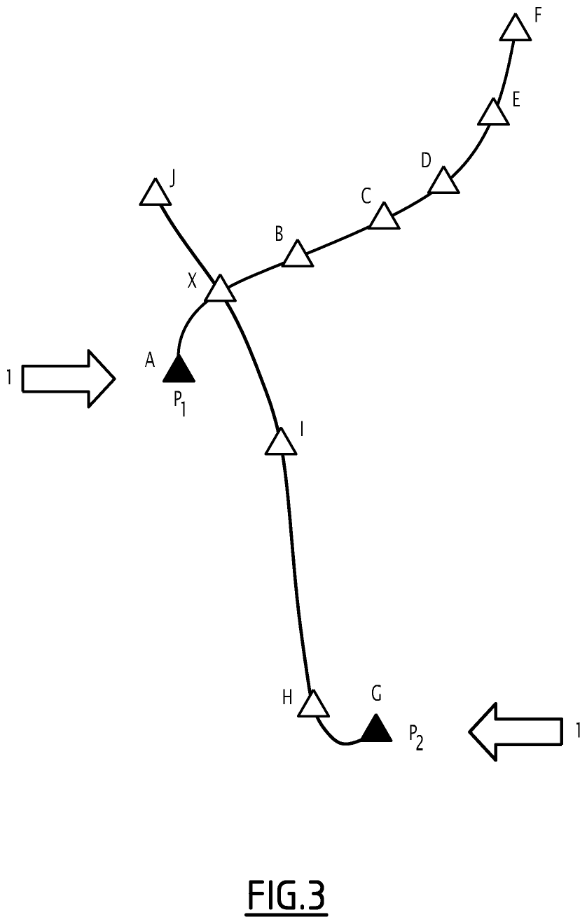

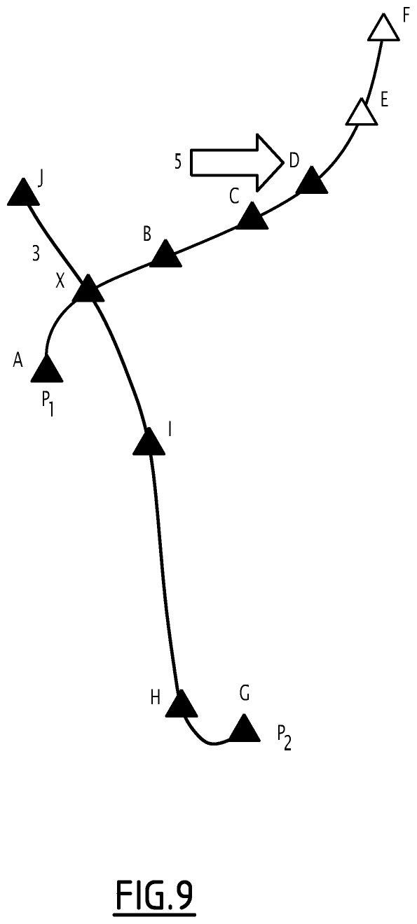

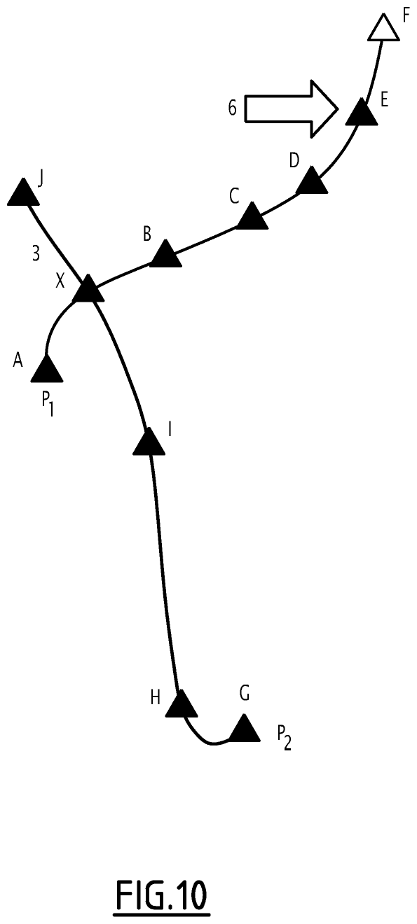

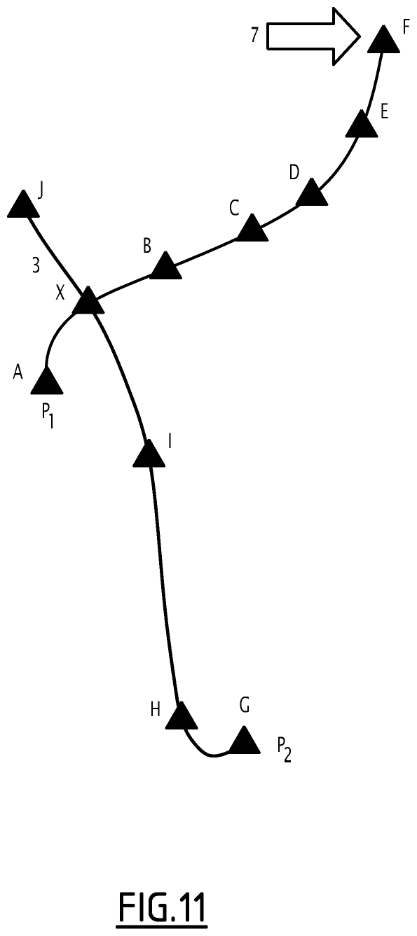

Thereafter, an example of the implementation of the method described above will be described with reference to FIGS. 3 to 11.

In particular, in this example the first flight plan identified on the figures by the reference P1, will be composed of the internal elements A, X, B, C, D, E, and F.

The first flight plan P7 therefore comprises seven interior elements.

The second flight plan is identified on the figures by P2 and comprises five internal elements, namely the internal elements G, H, I, X, and J.

FIG. 3 shows a first comparison of the elements of said flight plans where each of the scan indices is equal to 1.

Thus, as shown in FIG. 3, the elements A and G of the first flight plan P1 and of the second flight plan P2, respectively, are different.

Thus, during the sub-step 114, the processing unit 14 adds the two elements A and G in the resulting list and associates the element A with the marker “deleted” and the element G with the marker “added”.

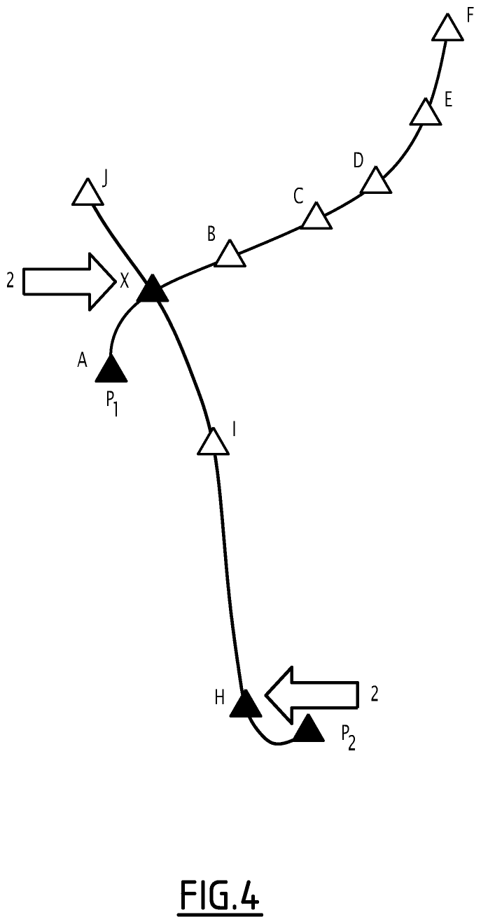

Then, during the sub-step 140, the processing unit increments each of the scan indices, which are both equal to two. The iteration of the step 110 is shown in FIG. 4.

Therefore, during the next comparison, the processing unit 14 compares the element X of the first flight plan P1 with the element H of the second flight plan P2.

Like in the previous case, said elements are distinct and none is present in the resulting list. Thus, during the sub-step 114, the processing unit 14 includes the two elements X and H in the resulting list and associates the element X with the marker “deleted” and the element H with the marker “added”.

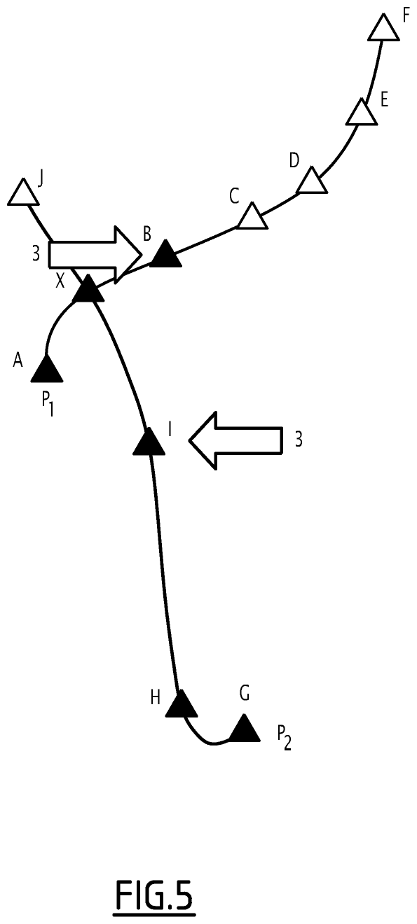

The same is true for the next iteration of the step 110 shown in FIG. 5 during which each of the scan indices is equal to 3.

Since the elements B and I are distinct and are not present in the resulting list, the processing unit 14 includes during the sub-step 114, the two elements B and I in the resulting list and associates the element B with the marker “deleted” and the element I with the marker “added”.

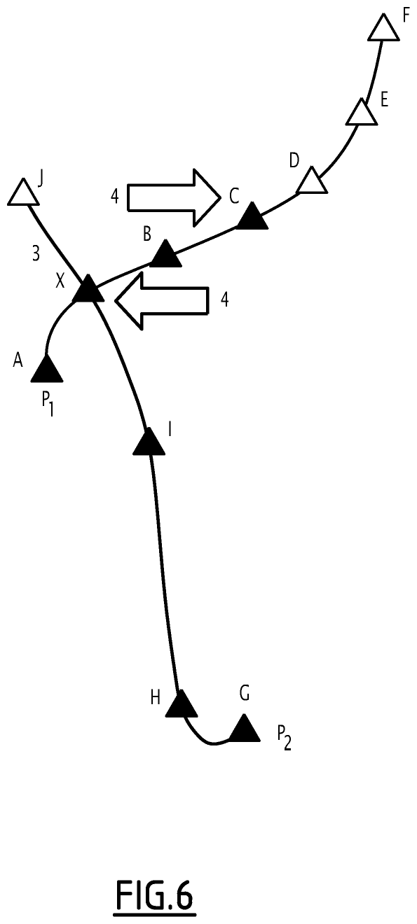

During the next run as shown in FIG. 6, the processing unit 14 compares the element C of the first flight plan P1 with the element X of the second flight plan P2. Although said elements are distinct, the element X is already present in the resulting list. It has indeed been processed in relation to the first flight plan P1.

Thus, during this scanning, the processing unit 14 implements the sub-steps 131 to 134.

In particular, during the sub-step 131, the processing unit 14 deletes from the resulting list, the element B having the marker “deleted”. Then, during the sub-step 132, the processing unit 14 changes in the resulting list, the marker of the element X to the marker “no difference”.

During the sub-step 133, the processing unit 14 puts the element X to the end of the resulting list.

Finally, during the sub-step 134, the processing unit 14 associates the position index of element X in the first flight plan P1 with the first scan index.

In other words, the processing unit 14 associates the index 2 with the first scan index.

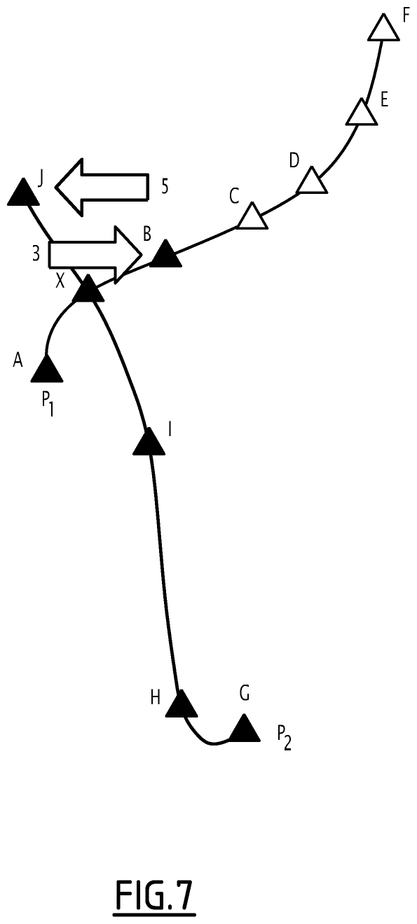

Then, during the next scanning shown in FIG. 7, the processing unit 14 compares the element B of the first flight plan with element J of the second flight plan P2.

Since the two elements are distinct and are not present in the resulting list, the processing unit 14 then implements the sub-step 114, during which said unit adds the two elements to the list, the element B being added with the marker “deleted and the element J being added with the marker “added”.

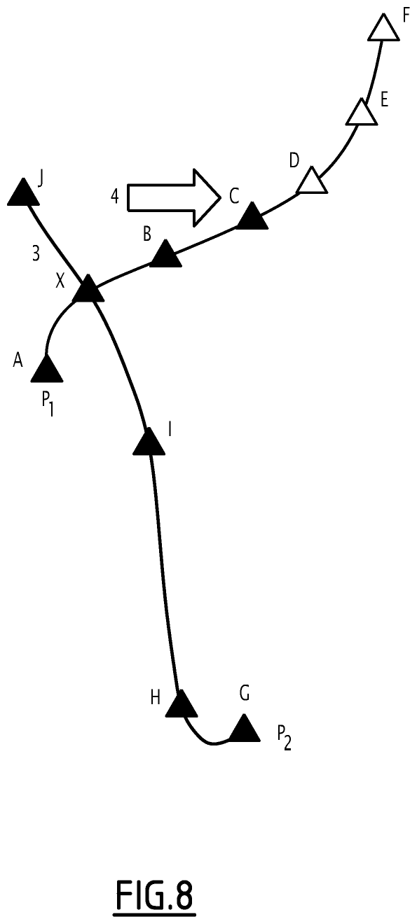

The following runs as shown in FIGS. 8 to 11 are implemented when the second scan index has already reached the total number of elements in the second flight plan P2.

Thus, each of the elements C, D, E, and F is added to the resulting list with the marker “deleted”. The execution of the comparison is completed when the first scan index reaches the total number of elements in the first flight plan P1, i.e. 7.

Thus, at the end of all the iterations of the step 110, the resulting list takes the following form:

A: deleted;

G: added;

H: added;

I: added;

X: no difference;

B: deleted;

J: added:

C: deleted;

D: deleted;

E: deleted;

F: deleted.

As explained before, the list is then processed during the steps 145, 150 and, if appropriate, 160.

The present invention then has a number of advantages.

First of all, the invention provides a synthetic view of the differences between at least two flight plans.

In particular, the resulting structure may be presented in a text form which is easily understandable as such, e.g. to be displayed on a screen or even printed on printing means located in the cockpit or elsewhere.

It is also possible to display different blocks of the resulting data structure by grouping together distinctive elements and common elements of different flight plans.

Furthermore, according to the invention, it is possible to compare not only interior elements and internal descriptive data of flight plans, but also external elements and external descriptive data associated with said flight plans. In this way, the pilot can have more comparison points for the flight plans, having e.g. substantially similar interior elements and interior descriptive data.

Finally, the resulting structure could be used as a basis for other systems, e.g. for displaying the differences between the flight plans or for merging or editing said flight plans.

1. A method for comparing at least two flight plans among a first flight plan and a second flight plan, each flight plan being associated with an ordered list of elements, each element being associated with a position index defining the position of the element on the list;
the method comprising:
a step of simultaneous scanning of the list of elements of the first flight plan according to a first scan index and of the list of elements of the second flight plan according to a second scan index;
the scan step comprising for each given pair of a first scan index and a second scan index, a comparison between the element, called first element, of the first flight plan whose position index corresponds to the first scan index and the element, called second element, of the second flight plan whose position index corresponds to the second scan index, according to the following sub-steps:
when the first element is identical to the second element, adding at least one of said elements in a resulting list with a “no difference” marker;
when the first element is not identical to the second element and none of said elements is yet present in the resulting list, adding in the resulting list, the first element with a “deleted” marker and the second element with an “added” marker;
incrementing each of the scan indices;
forming a data structure comprising the elements from all the flight plans in the order determined by the resulting list and for each of said elements, the corresponding marker.

2. The method according to claim 1, wherein the comparison of the first element with the second element further comprises the following sub-step:
when the first element is not identical to the second element and the first element corresponds to an element, called the preceding element, of the second flight plan which was already processed during a previous comparison;
deleting all elements from the resulting list after the preceding element, having the marker “added”;
changing the marker of the preceding element to the “no difference” marker;
in the resulting list, moving the preceding element to the end of said resulting list;
setting the second scan index equal to the position index of the preceding element.

3. The method according to claim 1, wherein the comparison of the first element with the second element further comprises the following sub-step:
when the first element is not identical to the second element and the first element corresponds to an element, called the preceding element, of the second flight plan which was already processed during a previous comparison;
deleting from the resulting list, all elements after the preceding element, having the marker “added”;
changing the marker of the preceding element to the marker “no difference”;
in the resulting list, moving the preceding element to the end of said resulting list;
setting the first scan index equal to the position index of the preceding element.

4. The method according to claim 1, wherein each flight plan further comprises descriptive data for each element, the method further comprising the following step:
scanning the resulting list and for each scanned element with the “no difference” marking, comparing the descriptive data associated with each flight plan with the element corresponding to the scanned element and when said data are different, modifying the marker of the scanned element to a marker “modified”.

5. The method according to claim 1, wherein during the comparison, the first path index or the second path index exceeds the maximum number of elements in the first flight plan or the second flight plan, respectively, the first element or the second element is considered as an empty element not present in the resulting list and not identical to the second element and to the first element, respectively.

6. The method according to claim 1, further comprising an analysis step of the resulting data structure comprising the formation of at least one block of unmodified common elements and of at least one block of distinctive elements;
the block or each block of distinctive elements being composed of one or more consecutive elements in the resulting list which have the marker “added” or “deleted”; and
the block or each block of unmodified common elements consisting of one or more consecutive elements of the resulting list having the marker “no difference.”

7. The method according to claim 6 taken in combination with claim 4, wherein the analysis step further comprises the formation of at least one block of modified common elements;
the block or each block of modified common elements consisting of one or a plurality of consecutive elements of the resulting list having the marker “modified.”

8. The method according to claim 1, wherein the data structure shows in a text form comprising with regard to each element of the resulting list, the marker associated with said element.

9. The method according to claim 1, wherein each element associated with a flight plan is an internal element comprised in said flight plan.

10. The method according to claim 1, wherein each element associated with a flight plan is an external element associated with an internal element included in said flight plan.

11. A computer program product containing software instructions which, when implemented by computer hardware, implement the method according to claim 1.

12. A comparison module of at least two flight plans among a first flight plan and a second flight plan comprising technical resources configured for implementing the method according to claim 1.
